(19) United States
(12) Patent Application Publication
(10) Pub. No.: US 2017/0260391 A1
(43) Pub. Date: Sep. 14, 2017

(54) POLYAMIDE-BASED FIBER FOR ARTIFICIAL HAIR HAVING EXCEPTIONAL DRIPPING RESISTANCE UPON COMBUSTION

(71) Applicant: Denka Company Limited, Chuo-ku, Tokyo (JP)

(72) Inventors: Yudai Ogawa, Kamakura-shi (JP); Kouta Nagaoka, Kamakura-shi (JP); Atsushi Horihata, Kamakura-shi (JP); Shigeharu Yoshii, Kamakura-shi (JP); Atsushi Takei, Kamakura-shi (JP)

(73) Assignee: Denka Company Limited, Chuo-ku, Tokyo (JP)

(21) Appl. No.: 15/529,846

(22) PCT Filed: Sep. 9, 2015
(86) PCT No.: PCT/JP2015/075597

§ 371 Date: May 25, 2017

(30) Foreign Application Priority Data
Dec. 9, 2014 (JP) 2014-249015

(51) Int. Cl. C08L 77/06; D01F 6/90; A41G 3/00

(52) U.S. Cl. CPC C08L 77/06; A41G 3/00; D01F 6/90; C08L 2201/02; C08L 2203/12; C08L 2205/025; C08L 2205/16; C08L 2205/22

(57) ABSTRACT

Polyamide-based fiber for artificial hair that is excellent in drip resistance, texture, and productivity is provided. According to the present invention, provided is fiber for artificial hair, including a resin composition containing: aliphatic polyamide; semi-aromatic polyamide with a skeleton obtained by polycondensation of aliphatic diamine and aromatic dicarboxylic acid; and a bromine-based flame retardant.

### TECHNICAL FIELD

The present invention relates to fiber used for artificial hair, such as wigs, hairpieces, and hair extensions, allowed to be put on and off of the head (hereinafter, simply referred to as “fiber for artificial hair”).

### BACKGROUND ART

As described in PTL 1, materials making up fiber for artificial hair include vinyl chloride resins. This is because vinyl chloride resins in the fiber for artificial hair are excellent in processability, cost reduction, and the like.

In fiber for artificial hair using a vinyl chloride resin as a material, such a vinyl chloride resin is poor in heat resistance to heat from a curling iron and the like. For curling with a curling iron or the like generally set at a temperature of 100° C. or more, such fiber may thus be fused and frizzled and sometimes results in damage and breaking of the fiber. Accordingly, polyamide based fiber for artificial hair is under development, which is highly heat resistant.

Polyamide unfortunately has a risk of dropping a molten resin during combustion and may cause burning due to contact with the molten resin. It is thus desired to give performance resistant to melt dripping during combustion (hereinafter, simply referred to as “drip resistance”).

PTL 2 discloses fiber for artificial hair produced by fiberizing a resin composition containing polyamide and a bromine-based flame retardant. Addition of the bromine-based flame retardant to polyamide improves the drip resistance of polyamide, and the problems of the fiber for artificial hair using polyamide as a material are solved to some extent.

### CITATION LIST

### Patent Literature

PTL 1: JP 2004-156149A
PTL 2: JP 2011-246844A

### SUMMARY OF INVENTION

Technical Problem

The fibers for artificial hair using aliphatic polyamide as a material provide good texture like human hair while having a risk of dripping the molten resin during combustion as described above, and thus it is desired to give drip resistance from the perspective of the safety of a wearer.

To give drip resistance to polyamide, a flame retardant is generally added. As the flame retardant, bromine-based flame retardants, phosphorus-based flame retardants, nitrogen-based flame retardants, hydrated metal compounds, and the like are commercially available. Among them, combination of a bromine-based flame retardant and an auxiliary flame retardant is considered to have the highest combustion inhibiting effect.

The combination of polyamide and a bromine-based flame retardant is not, however, compatible and causes insufficient dispersion of the bromine-based flame retardant in the polyamide resin during melt kneading. It thus has a problem of causing a defect, such as yarn breaking, during processing into a fibrous form, leading to significant reduction in productivity.

Accordingly, there is a need for improvement in the dispersion state of the bromine-based flame retardant in the polyamide resin to establish blend formulation of highly productive fiber for artificial hair.

The present invention has been made in view of such circumstances, and it is to provide drip-resistant polyamide-based fiber for artificial hair that provide good texture like human hair, is excellent in drip resistance, and is excellent in productivity.

Solution to Problem

According to the present invention, fiber for artificial hair is provided that includes a resin composition containing: at least one aliphatic polyamide; semi-aromatic polyamide with a skeleton obtained by polycondensation of aliphatic diamine and aromatic dicarboxylic acid; and a bromine-based flame retardant.

As a result of intensive examination to solve the above problems, the present inventors have found that fiber for artificial hair containing aliphatic polyamide, semi-aromatic polyamide with a skeleton obtained by polycondensation of aliphatic diamine and aromatic dicarboxylic acid, and a bromine-based flame retardant provides polyamide-based fiber for artificial hair having good drip resistance, excellent texture, and good productivity, and thus have come to complete the present invention.

### DESCRIPTION OF EMBODIMENTS

Descriptions below are given to embodiments of the present invention.

Fiber for artificial hair of the present invention contains a resin composition having respectively at least one or more of: aliphatic polyamide; semi-aromatic polyamide with a skeleton obtained by polycondensation of aliphatic diamine and aromatic dicarboxylic acid; and a bromine-based flame retardant. As described in experimental examples later, the fiber for artificial hair containing a mixture of the above three materials is understood to have good drip resistance, texture, and productivity.

The resin composition making up the fiber for artificial hair is described below in detail.

### Polyamide

The fiber for artificial hair of the present invention contains a resin composition having respectively at least one or more of: aliphatic polyamide; and semi-aromatic polyamide with a skeleton obtained by polycondensation of aliphatic diamine and aromatic dicarboxylic acid.

The aliphatic polyamide is polyamide having no aromatic ring. Examples of the aliphatic polyamide include n-nylon formed by ring-opening polymerization of lactam and n,m-nylon synthesized by co-polycondensation reaction of aliphatic diamine and aliphatic dicarboxylic acid. Lactam preferably has a carbon number from 6 to 12 and more preferably of 6. Aliphatic diamine and aliphatic dicarboxylic acid respectively preferably have a carbon number from 6 to 12 and more preferably of 6. Aliphatic diamine and aliphatic dicarboxylic acid preferably have a functional group (amino group or carboxyl group) at both ends of the carbon chain, while the functional groups may be in positions other than the both ends. The carbon chain is preferably linear, while it may be branched. Examples of such aliphatic polyamide include polyamide 6 and polyamide 66. From the perspective of heat resistance, polyamide 66 is preferred. Specific examples of such polyamide 6 include CM1007, CM1017, CM1017XL3, CM1017K, and CM1026 produced by Toray Industries, Inc. Examples of such polyamide 66 include CM3007, CM3001-N, CM3006, and CM3301L produced by Toray Industries, Inc., Zytel 101 and Zytel 42A produced by Du Pont K.K., and LEONA 1300S, 1500, and 1700 produced by Asahi Kasei Chemicals Corp.

Examples of such semi-aromatic polyamide with a skeleton obtained by polycondensation of aliphatic diamine and aromatic dicarboxylic acid include polyamide 6T, polyamide 9T, and polyamide 10T, as well as modified polyamide 6T, modified polyamide 9T, and modified polyamide 10T that are produced by copolymerizing a monomer for modification based thereon. Among them, polyamide 10T is preferred for ease of melt molding. Aliphatic diamine preferably has a carbon number from 6 to 10 and more preferably of 10. Aliphatic diamine preferably has an amino group at both ends of the carbon chain while the amino groups may be in positions other than the both ends. The carbon chain is preferably linear while it may be branched. Examples of such aromatic dicarboxylic acid include phthalic acid, isophthalic acid, terephthalic acid, and the like. Among them, terephthalic acid is most preferred.

Specific examples of such polyamide 6T and modified polymers thereof include VESTAMID HP Plus M1000 produced by Evonik Industries AG, ARLEN produced by Mitsui Chemicals, Inc., and the like. Examples of such polyamide 9T and modified polymers thereof include Genestar produced by Kuraray Co., Ltd. Examples of such polyamide 10T and modified polymers thereof include VESTAMID HO Plus M3000 produced by Evonik Japan Co., Ltd., Grivory produced by EMS-CHEMIE AG, and the like.

The aliphatic polyamide and the semi-aromatic polyamide are mixed at a ratio preferably ranging from 50 parts by mass/50 parts by mass to 99 parts by mass/1 part by mass and more preferably ranging from 70 parts by mass/30 parts by mass to 90 parts by mass/10 parts by mass. It is understood that a ratio of the semi-aromatic polyamide less than the above range causes a decrease in the effect of productivity improvement by adding the semi-aromatic polyamide. While fiber for artificial hair containing aliphatic polyamide provides good texture like human hair as described above, it is understood that a ratio of the semi-aromatic polyamide greater than the above range causes a decrease in the texture.

The aliphatic polyamide has a weight average molecular weight (Mw), for example, from 65 thousand to 150 thousand. Mw of more than 65 thousand results in particularly good drip resistance, whereas Mw of more than 150 thousand causes an increase in melt viscosity of the material and poor processability for fiberization. Mw is thus preferably 150 thousand or less. Considering the balance between the drip resistance and the processability, Mw is more preferably from 70 thousand to 120 thousand.

### Bromine-Based Flame Retardant

The fiber for artificial hair of the present invention contains at least one or more of bromine-based flame retardants. The flame retardant is added in an amount preferably from 3 to 30 parts by mass based on a total of 100 parts by mass of an amount of the aliphatic polyamide and an amount of the semi-aromatic polyamide with a skeleton obtained by polycondensation of aliphatic diamine and aromatic dicarboxylic acid, and more preferably from 10 to 30 parts by mass. This is because the balance between the drip resistance giving effect and the processability is good within the above range.

Examples of the bromine-based flame retardant include brominated phenol condensates, brominated polystyrene resins, brominated benzil acrylate-based flame retardants, brominated epoxy resins, brominated phenoxy resins, brominated polycarbonate resins, and bromine-containing triazine-based compounds. Specific examples of such brominated phenol condensate include SR-460B produced by DKS Co. Ltd. Examples of such brominated polystyrene resin include HP-7010 and HP-3010 produced by Albemarle Corp., PS900 and PL1200 produced by Manac Inc., PDBS-80 and PBS-64HW produced by Chemtura Japan Ltd., FCP-8000 and FCP-8000ST produced by Suzuhiro Chemical Co., Ltd., and the like. Examples of such brominated benzil acrylate-based flame retardant include FR-1025 produced by ICL. Examples of such brominated epoxy resin include SRT-20000, SRT-5000, SRT-2000, SRT-7040, and SRT-3040 produced by Sakamoto Yakuhin Kogyo Co., Ltd., F-2100, F-2300H, F-2400, and F-2400H produced by ICL Japan Ltd., and the like. Examples of such brominated phenoxy resin include YPB-43C and YPB-43M produced by Nippon Steel & Sumikin Chemical Co., Ltd. Examples of such brominated polycarbonate resin include Fire Guard FG-7000, Fire Guard FG-7500, and Fire Guard FG-8500 produced by Teijin Ltd. Examples of such bromine-containing triazine-based compound include SR-245 produced by DKS Co. Ltd. Among all, considering the balance between drip resistance, processability, transparency of the yarn, and the like, a brominated epoxy resin or a brominated phenoxy resin having a structural formula (1) below is preferred.

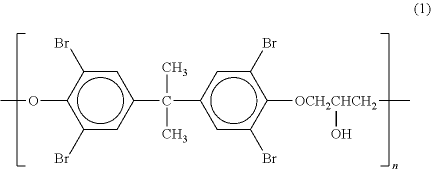

### Auxiliary Flame Retardant

The fiber for artificial hair of the present invention contains an auxiliary flame retardant in addition to aliphatic polyamide, semi-aromatic polyamide with a skeleton obtained by polycondensation of aliphatic diamine and aromatic dicarboxylic acid, and a bromine-based flame retardant, for further improvement in the drip resistance and the self-extinguishing properties, which is preferred. Examples of the auxiliary flame retardant include antimony trioxide, antimony tetroxide, antimony pentoxide, sodium antimonate, zinc borate, and zinc stannate. Among them, for the balance between the drip resistance and the transparency of the yarn, antimony trioxide is preferred.

The auxiliary flame retardant is preferably added in an amount from 0.1 to 10 parts by mass based on a total of 100 parts by mass of an amount of the aliphatic polyamide and an amount of the semi-aromatic polyamide with a skeleton obtained by polycondensation of aliphatic diamine and aromatic dicarboxylic acid and more preferably from 1 to 5 parts by mass. This is because the balance between the drip resistance, the self-extinguishing properties, the processability, and the transparency of the yarn is best within the above range. If the auxiliary flame retardant is added in an amount more than the above range, the transparency of the yarn and the processability are reduced. If the auxiliary flame retardant is added in an amount less than the above range, the effects of improving the drip resistance and the self-extinguishing properties are reduced.

From the perspective of the transparency of the yarn and the processability, the auxiliary flame retardant has an average particle size preferably ranging from 1 to 10 μm and more preferably ranging from 3 to 8 μm. The “average particle size” herein means a particle size with an integrated value of 50% in the particle size distribution obtained by laser diffraction scattering.

The auxiliary flame retardant may be a combination of plural items from the group consisting of antimony trioxide, antimony tetroxide, antimony pentoxide, sodium antimonate, zinc borate, and zinc stannate or a composite of two or more from the group.

### Organic Microparticle

By further addition of organic microparticles, the fiber for artificial hair of the present invention has more improved low glossiness and is allowed to have an appearance more like human hair.

Examples of the organic microparticles include crosslinked nitrile rubber, a crosslinked acrylic resin, crosslinked polyester, crosslinked polyamide, a crosslinked silicone resin, a crosslinked polystyrene resin, and a crosslinked polyethylene resin. Among them, crosslinked nitrile rubber is preferred. According to experiments by the present inventors, the resin composition containing organic or inorganic microparticles or the like for reduction of glossiness of the fiber tends to cause whitening of the fiber after drawing. Accordingly, for predetermined coloring of the resin composition, the amount of colorant to be added sometimes has to be increased. Crosslinked nitrile rubber is preferred because, in spite of such tendency, addition of organic microparticles containing crosslinked nitrile rubber inhibits such whitening.

The crosslinked nitrile rubber has an AN ratio preferably ranging from 30 to 50 mass %. This is because addition of crosslinked nitrile rubber in the above range leads to particularly good processability of the fiber for artificial hair.

Considering the balance between the glossiness reduction effect by the organic microparticles and other properties, the organic microparticles are added in an amount from 3 to 30 parts by mass based on a total of 100 parts by mass of an amount of the aliphatic polyamide and an amount of the semi-aromatic polyamide and more preferably from 5 to 20 parts by mass.

The organic microparticles preferably have an average particle size from 0.05 to 15 μm, more preferably from 0.05 to 10 μm, and even more preferably from 0.05 to 5 μm. This is because such a range has sufficiently large effects of controlling a gloss and a shine and also does not easily cause reduction in fiber strength due to addition of the microparticles.

### Other Additives

The resin composition used in the present embodiment may contain, in addition to polyamide, additives such as heat resistant agents, light stabilizers, fluorescent agents, antioxidants, antistatic agents, pigments, dyes, plasticizers, and lubricants, as needed. Such colorants, such as pigments and dyes, may be contained to produce precolored fiber (so-called spun-dyed fiber).

### Production Process

Descriptions are given below to an example of production process of the fiber for artificial hair, which does not limit the present invention.

First, the aliphatic polyamide, the semi-aromatic polyamide, and the bromine-based flame retardant described above are melt kneaded. As an apparatus for melt kneading, various general kneaders may be used. Examples of such a melt kneader include a single-screw extruder, a twin-screw extruder, a roll, a banbury mixer, a kneader, and the like. Among them, a twin-screw extruder is preferred in point of control of the degree of kneading and the ease of operation. The fiber for artificial hair is produced by general melt spinning in an appropriate temperature condition depending on the type of polyamide.

When polyamide 66 as the aliphatic polyamide and polyamide 10T as the semi-aromatic polyamide are used at a ratio of 80 parts by mass/20 parts by mass, a melt spinning device such as an extruder, a spinneret, and a gear pump as needed is set at a temperature from 270 to 310° C. for melt spinning. The resin is cooled in a tank filled with cooling water, and while controlling the fineness, the take up speed is adjusted to obtain undrawn yarn. The temperature of the melt spinning apparatus may be controlled as appropriate for the amount ratio of aliphatic polyamide and semi-aromatic polyamide. The cooling is not limited to be in a tank and spinning by cooling with cold air is also applicable. The temperature of the cooling tank, the temperature of cold air, the cooling time, and the take up speed may be appropriately controlled in accordance with the discharge and the number of holes in the spinneret.

For melt spinning, a spinning nozzle with nozzle holes in a special shape, not only in a simple circular shape, may be used to produce artificial hair fiber with a cross section in a deformed shape, such as an oval shape, a Y shape, an H shape, an X shape, and a flower shape.

The undrawn yarn thus obtained is subjected to drawing for improvement in tensile strength of the fiber. The drawing may be in either method of: the two-step method where the undrawn yarn is once taken up on a bobbin to be drawn in a step separate from the melt spinning; and direct spin drawing where drawing is performed continuously from the melt spinning without taking up on a bobbin. The drawing is performed by single-stage drawing to draw to the target draw ratio at a time or multi-stage drawing to draw to the target draw ratio in drawing at two or more times. A heating mechanism in a case of hot drawing may be a heating roller, a heating plate, a steam jet apparatus, a hot water tank, and the like, and they may be used in combination as appropriate.

The fiber for artificial hair in the present embodiment preferably has fineness from 10 to 150 dtex, more preferably from 30 to 150 dtex, and even more preferably from 35 to 120 dtex.

### EXAMPLES

Then, Examples of the fiber for artificial hair by the present invention are described in detail with reference to tables in comparison with Comparative Examples. The present invention is then described even more specifically based on Examples, which do not limit the present invention.

An aliphatic polyamide resin, a semi-aromatic polyamide resin, and a bromine-based flame retardant that were dried to have a moisture absorption of less than 1000 ppm were blended at blend ratios for Examples and Comparative Examples in Tables 1 to 5. The numerical values of amounts of polyamide, flame retardants, auxiliary flame retardants, and organic microparticles in Tables 1 to 5 are in parts by mass. The blended material was kneaded using a y 30 mm twin-screw extruder to obtain spinning material pellets.

The pellets were then dehumidified and dried to have a moisture absorption of 1000 ppm or less, followed by spinning using a φ 40 mm single spindle melt spinner. The molten resin delivered from a die with a hole diameter of 0.5 mm was cooled through a water tank at approximately 30° C. while the discharge and the take up speed were controlled to prepare undrawn yarn at preset fineness. The φ 40 mm melt spinner was set at a temperature appropriately controlled in accordance with the ratio of the amounts of aliphatic polyamide and semi-aromatic polyamide and the amount of the bromine-based flame retardant.

The undrawn yarn thus obtained was drawn at 100° C., followed by annealing from 150° C. to 200° C. to produce fiber for artificial hair at predetermined fineness. The draw ratio was 3 and a relaxation rate for annealing was from 0.5% to 3%. The relaxation rate for annealing is a value calculated by (rotation speed of take up roller during annealing)/(rotation speed of feed roller during annealing).

The fiber for artificial hair thus obtained was evaluated for the glossiness, self-extinguishing properties, drip resistance, texture, processability, and transparency in accordance with evaluation methods and criteria described later. Results are shown in Tables 1 to 5.

TABLE 1

| | | | Examples | | | | | | | | | | | | | |
|---|---|---|---|---|---|---|---|---|---|---|---|---|---|---|---|---|
| | | | 1 | 2 | 3 | 4 | 5 | 6 | 7 | 8 | 9 | 10 | 11 | 12 | 13 | 14 |
| Aliphatic Polyamide | Polyamide 66 | Weight Average Molecular | | | | | | | | | | | 80 | | | |
| Resin | | Weight of 120000 | | | | | | | | | | | | | | |
| | | Weight Average Molecular | 80 | 80 | 80 | 99.5 | 99 | 90 | 70 | 50 | 40 | 20 | | | | |
| | | Weight of 90000 | | | | | | | | | | | | | | |
| | | Weight Average Molecular | | | | | | | | | | | | 80 | | |
| | | Weight of 65000 | | | | | | | | | | | | | | |
| | | Weight Average Molecular | | | | | | | | | | | | | 80 | |
| | | Weight of 50000 | | | | | | | | | | | | | | |
| | Polyamide 6 | Weight Average Molecular | | | | | | | | | | | | | | 80 |
| | | Weight of 90000 | | | | | | | | | | | | | | |

| | | | | | | | | | | | | | | | |
|---|---|---|---|---|---|---|---|---|---|---|---|---|---|---|---|
| Semi-Aromatic | Polyamide 10T | 20 | | | 0.5 | 1 | 10 | 30 | 50 | 60 | 80 | 20 | 20 | 20 | 20 |
| Polyamide Resin | Polyamide 9T | | 20 | | | | | | | | | | | | |
| | Polyamide 6T | | | 20 | | | | | | | | | | | |
| Bromine-Based Flame | Brominated Epoxy Resin | 15 | 15 | 15 | 15 | 15 | 15 | 15 | 15 | 15 | 15 | 15 | 15 | 15 | 15 |
| Retardant | | | | | | | | | | | | | | | |
| Evaluation | Glossiness | ◯ | ◯ | ◯ | ◯ | ◯ | ◯ | ◯ | ◯ | ◯ | ◯ | ◯ | ◯ | ◯ | ◯ |
| | Transparency | ⊙ | ⊙ | ⊙ | ◯ | ◯ | ⊙ | ⊙ | ⊙ | ⊙ | ⊙ | ⊙ | ⊙ | ⊙ | ⊙ |
| | Texture | ⊙ | ◯ | ⊙ | ⊙ | ⊙ | ⊙ | ⊙ | ⊙ | ◯ | Δ | ⊙ | ⊙ | ⊙ | ⊙ |
| | Drip Resistance | ◯ | Δ | Δ | ◯ | ◯ | ◯ | ◯ | ◯ | ◯ | ◯ | ◯ | ◯ | Δ | ◯ |
| | Self-Extinguishing Properties | Δ | Δ | Δ | Δ | Δ | Δ | Δ | Δ | Δ | Δ | Δ | Δ | Δ | Δ |
| | Processability | ⊙ | ◯ | ◯ | Δ | ◯ | ⊙ | ⊙ | ⊙ | ⊙ | ⊙ | ⊙ | ⊙ | ⊙ | ⊙ |

TABLE 2

| | | | Examples | | | | | | | | | | | |
|---|---|---|---|---|---|---|---|---|---|---|---|---|---|---|
| | | | 15 | 16 | 17 | 18 | 19 | 20 | 21 | 22 | 23 | 24 | 25 | 26 |
| Aliphatic Polyamide | Polyamide 66 | Weight Average Molecular | 80 | 80 | 80 | 80 | 80 | 80 | 80 | 80 | 80 | 80 | 80 | 80 |
| Resin | | Weight of 90000 | | | | | | | | | | | | |

| | | | | | | | | | | | | | |
|---|---|---|---|---|---|---|---|---|---|---|---|---|---|
| Semi-Aromatic | Polyamide 10T | 20 | 20 | 20 | 20 | 20 | 20 | 20 | 20 | 20 | 20 | 20 | 20 |
| Polyamide Resin | | | | | | | | | | | | | |
| Bromine-Based Flame | Brominated Epoxy Resin | | | | | | | 1 | 3 | 10 | 20 | 30 | 40 |
| Retardant | Brominated Polystyrene Resin | 15 | | | | | | | | | | | |
| | Brominated Phenoxy Resin | | 15 | | | | | | | | | | |
| | Brominated Phenol Condensate | | | 15 | | | | | | | | | |
| | Brominated Benzil Acrylate-Based Flame Retardant | | | | 15 | | | | | | | | |
| | Brominated Polycarbonate Resin | | | | | 15 | | | | | | | |
| | Bromine-Containing Triazine-Based Compound | | | | | | 15 | | | | | | |
| Evaluation | Glossiness | ◯ | ◯ | ◯ | ◯ | ◯ | ◯ | Δ | Δ | ◯ | ◯ | ◯ | ◯ |
| | Transparency | ◯ | ⊙ | ⊙ | ⊙ | ◯ | ◯ | ⊙ | ⊙ | ⊙ | ⊙ | ⊙ | ⊙ |
| | Texture | ⊙ | ⊙ | ⊙ | ⊙ | ⊙ | ⊙ | ⊙ | ⊙ | ⊙ | ⊙ | ⊙ | ◯ |
| | Drip Resistance | ◯ | ◯ | ◯ | ◯ | ◯ | ◯ | Δ | ◯ | ◯ | ◯ | ⊙ | ⊙ |
| | Self-Extinguishing Properties | Δ | Δ | Δ | Δ | Δ | Δ | x | Δ | Δ | Δ | ◯ | ◯ |
| | Processability | ⊙ | ⊙ | ◯ | ◯ | ◯ | ◯ | ⊙ | ⊙ | ⊙ | ⊙ | ◯ | Δ |

TABLE 3

| | | | Examples | | | | | | | |
|---|---|---|---|---|---|---|---|---|---|---|
| | | | 27 | 28 | 29 | 30 | 31 | 32 | 33 | 34 |
| Aliphatic Polyamide | Polyamide 66 | Weight Average Molecular | 80 | 80 | 80 | 80 | 80 | 80 | 80 | 80 |
| Resin | | Weight of 90000 | | | | | | | | |
| Semi-Aromatic | Polyamide 10T | | 20 | 20 | 20 | 20 | 20 | 20 | 20 | 20 |
| Polyamide Resin | | | | | | | | | | |
| Bromine-Based Flame | Brominated Epoxy Resin | | 15 | 15 | 15 | 15 | 15 | 15 | 15 | 15 |
| Retardant | | | | | | | | | | |
| Auxiliary Flame | Antimony Trioxide | Average Particle Size of 0.5 μm | | | | | | | 1.5 | |
| Retardant | | Average Particle Size of 1.2 μm | | | | | | | | 1.5 |
| | | Average Particle Size of 3 μm | 1.5 | | | | | | | |
| | | Average Particle Size of 8 μm | | | | | | | | |
| | | Average Particle Size of 10 μm | | | | | | | | |
| | | Average Particle Size of 12 μm | | | | | | | | |
| | Antimony Tetroxide | Average Particle Size of 3 μm | | 1.5 | | | | | | |
| | Antimony Pentoxide | Average Particle Size from 3 to 5 μm | | | 1.5 | | | | | |
| | Sodium Antimonate | Average Particle Size of 4 μm | | | | 1.5 | | | | |
| | Zinc Borate | Average Particle Size of 3 μm | | | | | 1.5 | | | |
| | Zinc Stannate | Average Particle Size of 3 μm | | | | | | 1.5 | | |
| Evaluation | Glossiness | | ◯ | ◯ | ◯ | ◯ | ◯ | ◯ | ◯ | ◯ |
| | Transparency | | ⊙ | ◯ | ◯ | ◯ | ◯ | ◯ | Δ | ◯ |
| | Texture | | ⊙ | ⊙ | ⊙ | ⊙ | ⊙ | ⊙ | ⊙ | ⊙ |
| | Drip Resistance | | ⊙ | ⊙ | ⊙ | ⊙ | ◯ | ◯ | ⊙ | ⊙ |
| | Self-Extinguishing Properties | | ◯ | ◯ | ◯ | ◯ | ◯ | ◯ | ◯ | ◯ |
| | Processability | | ⊙ | ⊙ | ⊙ | ⊙ | ⊙ | ⊙ | ⊙ | ⊙ |
| | | | 35 | 36 | 37 | 38 | 39 | 40 | 41 | 42 |
| Aliphatic Polyamide | Polyamide 66 | Weight Average Molecular | 80 | 80 | 80 | 80 | 80 | 80 | 80 | 80 |
| Resin | | Weight of 90000 | | | | | | | | |
| Semi-Aromatic | Polyamide 10T | | 20 | 20 | 20 | 20 | 20 | 20 | 20 | 20 |
| Polyamide Resin | | | | | | | | | | |
| Bromine-Based Flame | Brominated Epoxy Resin | | 15 | 15 | 15 | 15 | 15 | 15 | 15 | 15 |
| Retardant | | | | | | | | | | |
| Auxiliary Flame | Antimony Trioxide | Average Particle Size of 0.5 μm | | | | | | | | |
| Retardant | | Average Particle Size of 1.2 μm | | | | | | | | |
| | | Average Particle Size of 3 μm | | | 0.1 | | 3 | 5 | 10 | 13 |
| | | Average Particle Size of 8 μm | | | | | | | | |
| | | Average Particle Size of 10 μm | 1.5 | | | | | | | |
| | | Average Particle Size of 12 μm | | 1.5 | | | | | | |
| | Antimony Tetroxide | Average Particle Size of 3 μm | | | | | | | | |
| | Antimony Pentoxide | Average Particle Size from 3 to 5 μm | | | | | | | | |
| | Sodium Antimonate | Average Particle Size of 4 μm | | | | | | | | |
| | Zinc Borate | Average Particle Size of 3 μm | | | | | | | | |
| | Zinc Stannate | Average Particle Size of 3 μm | | | | | | | | |

| | | | | | | | | | |
|---|---|---|---|---|---|---|---|---|---|
| Evaluation | Glossiness | ◯ | ◯ | ◯ | ◯ | ◯ | ◯ | ◯ | ◯ |
| | Transparency | ⊙ | ◯ | Δ | ⊙ | ◯ | ◯ | ◯ | Δ |
| | Texture | ⊙ | ⊙ | ⊙ | ⊙ | ⊙ | ⊙ | ⊙ | ◯ |
| | Drip Resistance | ⊙ | ⊙ | ⊙ | ◯ | ⊙ | ⊙ | ⊙ | ⊙ |
| | Self-Extinguishing Properties | ◯ | ◯ | ◯ | ◯ | ⊙ | ⊙ | ⊙ | ⊙ |
| | Processability | ⊙ | ⊙ | ◯ | ⊙ | ⊙ | ⊙ | ◯ | ◯ |

TABLE 4

| | | | Examples | | | | | | | | |
|---|---|---|---|---|---|---|---|---|---|---|---|
| | | | 43 | 44 | 45 | 46 | 47 | 48 | 49 | 50 | 51 |
| Aliphatic Polyamide | Polyamide 66 | Weight Average Molecular | 80 | 80 | 80 | 80 | 80 | 80 | 80 | 80 | 80 |
| Resin | | Weight of 90000 | | | | | | | | | |
| Semi-Aromatic | Polyamide 10T | | 20 | 20 | 20 | 20 | 20 | 20 | 20 | 20 | 20 |
| Polyamide Resin | | | | | | | | | | | |
| Auxiliary Flame | Antimony Trioxide | Average Particle Size of 3 μm | 1.5 | 1.5 | 1.5 | 1.5 | 1.5 | 1.5 | 1.5 | 1.5 | 1.5 |
| Retardant | | | | | | | | | | | |
| Organic Microparticles | Crosslinked Nitrile | AN Ratio of 25 mass % | | | 20 | | | | | | |
| | Rubber | AN Ratio of 35 mass % | | 20 | | | | | | | |
| | | AN Ratio of 45 mass % | 20 | | | | | 1 | 3 | 30 | 35 |

| | | | | | | | | | | |
|---|---|---|---|---|---|---|---|---|---|---|
| | Crosslinked Silicone Resin | | | | 20 | | | | | |
| | Crosslinked Acrylic Resin | | | | | 20 | | | | |
| Evaluation | Glossiness | ⊙ | ⊙ | ⊙ | ⊙ | ⊙ | ◯ | ⊙ | ⊙ | ⊙ |
| | Transparency | ⊙ | ⊙ | ⊙ | ⊙ | ◯ | ⊙ | ⊙ | ⊙ | ⊙ |
| | Texture | ⊙ | ⊙ | ⊙ | ⊙ | ⊙ | ⊙ | ⊙ | ⊙ | ⊙ |
| | Drip Resistance | ⊙ | ⊙ | ⊙ | ⊙ | ⊙ | ⊙ | ⊙ | ⊙ | ◯ |
| | Self-Extinguishing Properties | ◯ | ◯ | ◯ | ◯ | ◯ | ◯ | ◯ | ◯ | Δ |
| | Processability | ⊙ | ⊙ | ◯ | ◯ | ⊙ | ⊙ | ⊙ | ⊙ | ◯ |

TABLE 5

| | | | Comparative Examples | | | | | | | | |
|---|---|---|---|---|---|---|---|---|---|---|---|
| | | | 1 | 2 | 3 | 4 | 5 | 6 | 7 | 8 | 9 |
| Aliphatic Polyannide | Polyamide 66 | Weight Average Molecular | 100 | | | | | 100 | 100 | 100 | 80 |
| Resin | | Weight of 90000 | | | | | | | | | |
| | | Weight Average Molecular | | 100 | | | | | | | |
| | | Weight of 50000 | | | | | | | | | |

| | | | | | | | | | | |
|---|---|---|---|---|---|---|---|---|---|---|
| Semi-Aromatic Polyamide | Polyannide 10T | | | 100 | | | | | | |
| Resin | Polyannide 9T | | | | 100 | | | | | |
| | Polyannide 6T | | | | | 100 | | | | |
| | Polyannide MXD6 | | | | | | | | | 20 |
| Bromine-Based Flame | Brominated Epoxy Resin | | | | | | 15 | | | 15 |
| Retardant | Brominated Polystyrene Resin | | | | | | | 15 | | |
| | Brominated Phenoxy Resin | | | | | | | | 15 | |
| Evaluation | Glossiness | xx | xx | xx | xx | xx | ◯ | ◯ | ◯ | ◯ |
| | Transparency | ⊙ | ⊙ | ⊙ | ⊙ | ⊙ | ◯ | ◯ | ◯ | ◯ |
| | Texture | ⊙ | ⊙ | x | x | x | ◯ | ◯ | ◯ | ◯ |
| | Drip Resistance | x | xx | x | x | x | ◯ | ◯ | ◯ | ◯ |
| | Self-Extinguishing Properties | x | xx | x | x | x | Δ | Δ | Δ | Δ |
| | Processability | ⊙ | ⊙ | ⊙ | ⊙ | ⊙ | xx | xx | xx | x |

Regarding the materials in Tables 1 to 5, the followings were employed.
Polyamide 66 (weight average molecular weight of 50000): AMILAN CM3001-N produced by Toray Industries, Inc.
Polyamide 66 (weight average molecular weight of 65000): LEONA 1500 produced by Asahi Kasei Chemicals Corp.
Polyamide 66 (weight average molecular weight of 90000): Zytel 42A produced by Du Pont K.K.
Polyamide 66 (weight average molecular weight of 120000): product of the applicant
Polyamide 6 (weight average molecular weight of 90000): product of the applicant
Polyamide 10T: VESTAMID HO Plus M3000 produced by Daicel-Evonik Ltd.
Polyamide 9T: Genestar N1000A-M42 produced by Kuraray Co., Ltd.
Polyamide 6T: VESTAMID HP Plus M1000 produced by Daicel-Evonik Ltd.
Polyamide MXD6: 56007 produced by Mitsubishi Gas Chemical Co, Inc.
Brominated epoxy resin: SRT-20000 produced by Sakamoto Yakuhin Kogyo Co., Ltd.
Brominated polystyrene resin: HP-7020 produced by Albemarle Corp.
Brominated phenoxy resin: YPB-43C produced by Nippon Steel & Sumikin Chemical Co., Ltd.
Brominated phenol condensate: PYROGUARD SR-460B produced by DKS Co. Ltd.
Brominated benzil acrylate-based flame retardant: FR-1025 produced by ICL-IP Ltd.
Bromine-containing triazine-based compound: PYROGUARD SR-245 produced by DKS Co. Ltd.
Antimony trioxide (average particle size of 0.5 μm): PATOX-M produced by Nihon Seiko Co., Ltd.
Antimony trioxide (average particle size of 1.2 μm): PATOX-K produced by Nihon Seiko Co., Ltd.
Antimony trioxide (average particle size of 3 μm): PATOX-P produced by Nihon Seiko Co., Ltd.
Antimony trioxide (average particle size of 8 μm): PATOX-L produced by Nihon Seiko Co., Ltd.
Antimony trioxide (average particle size of 10 μm): product of the applicant
Antimony trioxide (average particle size of 12 μm): product of the applicant
Antimony tetroxide (average particle size of 4 μm): ATE-S produced by Yamanaka & Co., Ltd.
Antimony pentoxide (average particle size from 3 to 5 μm): Sun Epoch NA-1030 produced by Nissan Chemical Industries, Ltd.
Sodium antimonite (average particle size of 4 μm): SA-A produced by Nihon Seiko Co., Ltd.
Zinc borate (average particle size of 3 μm): product of the applicant
Zinc stannate (average particle size of 3 μm): product of the applicant
Crosslinked nitrile rubber (AN ratio of 25 mass %): N240S produced by JSR Corp.
Crosslinked nitrile rubber (AN ratio of 35 mass %): Napo VP-402 produced by China Petrochemical Corp.
Crosslinked nitrile rubber (AN ratio of 45 mass %): BAYMOD N XL38.43 produced by Lanxess AG
Crosslinked silicone resin: EP5500 produced by Dow Corning Toray Co., Ltd.
Crosslinked acrylic resin: KMR-3TA produced by Soken Chemical & Engineering Co., Ltd.

The weight average molecular weight (Mw) in Tables 1 to 5 was measured by the following method.

### Weight Average Molecular Weight Mw

The weight average molecular weight Mw was obtained by measurement using the following equipment in the conditions below.

Apparatus used: Pump—shodex DS-4
Column—shodex GPC HFIP-806M×2+HFIP-803
Detector—shodex RI-71

Eluate: hexafluoroisopropanol (+additive CF3COONa (5 mmol/L))

Pretreatment: filtration with a membrane filter (0.2 μm)

Concentration: 0.2 w/v %

Injection volume: 100 μL

Column temperature: 40° C.

Flow rate: 1.0 ml/min.

Standard material: standard polymethyl methacrylate (PMMA)
Calibration curve was prepared using the standard PMMA to represent the weight average molecular weight as PMMA conversion value.

The evaluation items in Tables 1 to 5 were evaluated in the respective methods and criteria as below.

### Glossiness

The glossiness was visually observed for evaluation.

Three thousand fibers for artificial hair were prepared in a bundle with a length of 20 cm to be observed in the sunlight for determination in accordance with the following evaluation criteria.
⊙: Glossiness similar to human hair
◯: Glossiness not the same as but roughly close to human hair
Δ: Glossiness not the same as human hair but roughly available for use as fiber for artificial hair
×: Glossiness apparently different from human hair
××: Glossiness apparently different from human hair and noticeable glossiness typical of synthetic fiber

### Flammability (Self-Extinguishing Properties, Drip Resistance)

The flammability was evaluated in the aspects of “self-extinguishing properties” and “drip resistance”. For both aspects of evaluation, the fiber for artificial hair was cut with a length of 30 cm and the number of fibers with a weight of 2 g was separated to prepare a fiber bundle sample. An end of the fiber bundle was fixed to be vertically hung, and the lower end was in contact with a flame with a length of 20 mm for 5 seconds, followed by respective measurement of fire spread time after removal from the flame and the number of dripping during the time for determination as follows. For the result of measurement, an average of three measurements was used.

### Self-Extinguishing Properties

⊙: Fire spread time within 1 second
◯: Fire spread time of 2 seconds or more and less than 5 seconds
Δ: Fire spread time of 6 seconds or more and less than 10 seconds
×: Fire spread time of 10 seconds or more and less than 20 seconds
××: Fire spread time of 20 seconds or more

### Drip Resistance

⊙: No drippings found
◯: 1 or more and less than 2 drippings found
Δ: 3 or more and less than 5 drippings found
×: 6 or more and less than 10 drippings found
××: 10 or more drippings found

### Texture

The texture was evaluated by the evaluation criteria below, bundling each fiber for artificial hair in Examples and Comparative Examples with a length of 200 mm and a weight of 1.0 g to be touched with the hand of 10 artificial hair fiber treatment engineers (with 5 years or more of practical experience) for determination.
⊙: Evaluated as good texture by all 10 engineers
◯: Evaluated as good texture by 8 or 9 engineers
Δ: Evaluated as good texture by 5 or more and 7 or less engineers
×: Evaluated as good texture by 2 or more and 4 or less engineers
××: Evaluated as good texture by 1 or less engineer

### Processability

A bundle of 100 fibers of undrawn yarn was drawn at a draw ratio of 3 and the number of yarn breaking during the drawing was determined for evaluation by the following evaluation criteria.
⊙: 0 yarn breakings/30 min.
◯: 1 or more and less than 3 yarn breakings/30 min.
Δ: 3 or more and less than 10 yarn breakings/30 min.
×: 10 or more and less than 20 yarn breakings/30 min.
××: 20 or more yarn breakings/30 min.

### Transparency

The transparency was evaluated by the evaluation criteria below, bundling each fiber for artificial hair in Examples and Comparative Examples with a length of 200 mm and a weight of 1.0 g to be visually observed by 10 artificial hair fiber treatment engineers (with 5 years or more of practical experience) for comparison with human hair.
⊙: Transparency similar to human hair
◯: Transparency not the same as but roughly close to human hair
Δ: Transparency containing opacity slightly more than human hair but roughly available for use as fiber for artificial hair
×: Apparent opacity with difference from human hair
××: Apparent opacity and not available for use as fiber for artificial hair

### Discussion

As described in Examples and Comparative Examples above, it was found that use of a resin composition, as a material, containing aliphatic polyamide, semi-aromatic polyamide with a skeleton obtained by polycondensation of aliphatic diamine and aromatic dicarboxylic acid, and a bromine-based flame retardant enabled production of fiber for artificial hair having both drip resistance during combustion and excellent texture and productivity.

It was also found that addition of the auxiliary flame retardant in an appropriate amount allowed even more improvement in drip resistance and self-extinguishing properties during combustion and even more. It was further found that addition of the organic microparticles in an appropriate amount allowed the glossiness to be even more like human hair.

Examples and Comparative Examples are analyzed in more detail below.

Comparing Examples 1 to 3, it was found that the cases of using polyamide 10T or polyamide 6T, among semi-aromatic polyamides, provided particularly good texture and the case of using polyamide 10T provided particularly good drip resistance and processability.

Comparing Examples 1 and 4 to 10, it was found that the cases of using 50 parts by mass or more of aliphatic polyamide provided particularly good texture and the cases of using 10 parts by mass or more of semi-aromatic polyamide provided particularly good processability.

Comparing Examples 1 and 11 to 13, it was found that the cases of using aliphatic polyamide with a weight average molecular weight of 65 thousand or more provided particularly good drip resistance.

Comparing Examples 1 and 14, it was found that either case of using polyamide 66 or polyamide 6 as aliphatic polyamide provided the same evaluation results.

Comparing Examples 1 and 15 to 20, it was found that the case of using the brominated epoxy resin, the brominated polystyrene resin, or the brominated phenoxy resin as the bromine-based flame retardant provided particularly good processability. It was also found that the case of using the brominated epoxy resin, the brominated phenoxy resin, the brominated phenol condensate, or the brominated benzil acrylate-based flame retardant provided particularly good transparency. It was also found that the case of using the brominated epoxy resin or the brominated phenoxy resin provided particularly good processability and transparency. Since both the brominated epoxy resin and the brominated phenoxy resin used in Examples had the structural formula represented by the chemical formula (1), it was found that a bromine-based flame retardant having the structure of chemical formula (1) was most preferred.

Comparing Examples 21 to 26, it was found that the cases of using 3 parts by mass or more of the bromine-based flame retardant provided good self-extinguishing properties and the cases of 30 parts by mass or more provided particularly good self-extinguishing properties. It was also found that the cases of using 10 parts by mass or more of the bromine-based flame retardant provided particularly good glossiness. It was also found that the cases of using 30 parts by mass or less of the bromine-based flame retardant provided good processability and the cases of using 20 parts by mass or less provided particularly good processability.

Comparing Examples 27 to 32, it was found that the case of using antimony trioxide as the auxiliary flame retardant provided particularly good transparency and drip resistance. Comparing Examples 27 and 33 to 37, it was further found that the cases of using the auxiliary flame retardant with an average particle size from 1 to 10 μm provided good transparency and the cases from 3 to 8 μm provided particularly good transparency. Comparing Examples 27 and 38 to 42, it was further found that the cases of using from 0.1 to 10 parts by mass of the auxiliary flame retardant provided good texture and transparency and the cases from 1 to 5 parts by mass provided particularly good processability and drip resistance.

Comparing Examples 43 to 47, it was found that the case of using crosslinked nitrile rubber with an AN ratio from 30 to 50 mass % as the organic microparticles provided particularly good transparency and processability. Comparing Examples 43 and 48 to 51, it was found that the cases of using from 3 to 30 parts by mass of the organic microparticles provided particularly good glossiness, processability, and self-extinguishing properties.

Comparative Examples 1 to 5 containing no bromine-based flame retardant had poor drip resistance. Comparative Examples 6 to 8 containing no semi-aromatic polyamide had poor processability. Further, Comparative Example 9 containing polyamide MXD6, as semi-aromatic polyamide, with a skeleton obtained by polycondensation of aliphatic dicarboxylic acid and aromatic diamine did not have good processability. From these results, it was found that semi-aromatic polyamide with the specific skeleton was essential for improvement in processability.

1. Fiber for artificial hair, comprising a resin composition containing:
aliphatic polyamide (A); semi-aromatic polyamide (B) with a skeleton obtained by polycondensation of aliphatic diamine and aromatic dicarboxylic acid; and a bromine-based flame retardant (C).

2. The fiber of claim 1, wherein the aliphatic polyamide (A) includes at least one selected from polyamide 6 and polyamide 66, and the semi-aromatic polyamide (B) includes at least one selected from polyamide 6T, polyamide 9T, polyamide 10T, and a modified polymer thereof.

3. The fiber of claim 1, wherein the aliphatic polyamide (A) and the semi-aromatic polyamide (B) are mixed at a ratio ranging from 50 parts by mass/50 parts by mass to 99 parts by mass/1 part by mass.

4. The fiber of claim 1, wherein the aliphatic polyamide (A) has a weight average molecular weight Mw from 65 thousand to 150 thousand.

5. The fiber of claim 1, wherein the bromine-based flame retardant (C) is at least one selected from the group consisting of a brominated phenol condensate, a brominated polystyrene-based flame retardant, a brominated benzil acrylate-based flame retardant, a brominated epoxy-based flame retardant, a brominated phenoxy-based flame retardant, a brominated polycarbonate-based flame retardant, and a bromine-containing triazine-based compound.

6. The fiber of claim 1, wherein the bromine-based flame retardant (C) includes a compound structure represented by a chemical formula (1) below.

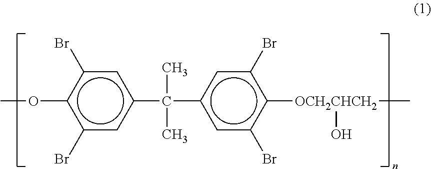

7. The fiber of claim 1, wherein the bromine-based flame retardant (C) is added in an amount from 3 to 30 parts by mass based on a total of 100 parts by mass of an amount of the aliphatic polyamide (A) and an amount of the semi-aromatic polyamide (B).

8. The fiber of claim 1, further comprising an auxiliary flame retardant (D).

9. The fiber of claim 8, wherein the auxiliary flame retardant (D) is at least one selected from the group consisting of antimony trioxide, antimony tetroxide, antimony pentoxide, sodium antimonate, zinc borate, and zinc stannate.

10. The fiber of claim 8, wherein the auxiliary flame retardant (D) has an average particle size ranging from 1 to 10 μm.

11. The fiber of claim 8, wherein the auxiliary flame retardant (D) is added in an amount from 0.1 to 10 parts by mass based on a total of 100 parts by mass of an amount of the aliphatic polyamide (A) and an amount of the semi-aromatic polyamide (B).

12. The fiber of claim 1, further comprising organic microparticles (E).

13. The fiber of claim 12, wherein the organic microparticles (E) are at least one selected from crosslinked nitrile rubber, a crosslinked acrylic resin, crosslinked polyester, crosslinked polyamide particles, a crosslinked silicone resin, a crosslinked polystyrene resin, and a crosslinked polyethylene resin.

14. The fiber of claim 12, wherein the organic microparticles (E) are crosslinked nitrile rubber.

15. The fiber of claim 12, wherein the crosslinked nitrile rubber has an AN ratio ranging from 30 to 50 mass %.

16. The fiber of claim 12, wherein the organic microparticles (E) are added in an amount from 3 to 30 parts by mass based on a total of 100 parts by mass of an amount of the aliphatic polyamide (A) and an amount of the semi-aromatic polyamide (B).
